(19) United States
(12) Patent Application Publication
(10) Pub. No.: US 2026/0214317 A1
(43) Pub. Date: Jul. 23, 2026

(54) FOCUSING APPARATUS, IMAGE PICKUP APPARATUS, FOCUSING METHOD, AND STORAGE MEDIUM

(71) Applicant: CANON KABUSHIKI KAISHA, Tokyo (JP)

(72) Inventor: TAKAYUKI AKAGUMA, Tokyo (JP)

(21) Appl. No.: 19/429,085

(22) Filed: Dec. 22, 2025

(30) Foreign Application Priority Data
Jan. 17, 2025 (JP) 2025-006715

(51) Int. Cl. H04N 23/61; H04N 23/63; H04N 23/67

(52) U.S. Cl. CPC H04N 23/61; H04N 23/632; H04N 23/67

(57) ABSTRACT

A focusing apparatus may include one or more processors that operate to detect an action of an object in an image acquired by shooting of the object, detect a shooting scene in the image, set a parameter for focusing, set the parameter to a first parameter in a case where the action of the object is not a specific action, set the parameter to a second parameter different from the first parameter in a case where the action of the object is the specific action, set the parameter to the first parameter in a case where the action of the object is the specific action and the shooting scene is not a specific shooting scene, and set the parameter to the second parameter in a case where the action of the object is the specific action and the shooting scene is the specific shooting scene.

### BACKGROUND

### Field of the Technology

The aspect of the disclosure relates to one or more embodiments of a focusing apparatus, an image pickup apparatus, a focusing method, and a storage medium.

### Description of the Related Art

Japanese Patent Application Laid-Open No. 2014-122978 discloses a configuration that changes a voice recognition condition based on the user's spoken voice and pre-registered voices.

### SUMMARY

One or more embodiments of a focusing apparatus according to one or more aspects of the disclosure may include one or more memories storing instructions, and one or more processors that, upon execution of the instructions, operate to detect an action of an object in an image acquired by shooting of the object, detect a shooting scene in the image, set a parameter for focusing, set the parameter to a first parameter in a case where the action of the object is not a specific action, set the parameter to a second parameter different from the first parameter in a case where the action of the object is the specific action, set the parameter to the first parameter in a case where the action of the object is the specific action and the shooting scene is not a specific shooting scene, and set the parameter to the second parameter in a case where the action of the object is the specific action and the shooting scene is the specific shooting scene. One or more embodiments of another focusing apparatus according to one or more aspects of the disclosure may include one or more memories storing instructions, and one or more processors that, upon execution of the instructions, operate to detect an action of an object in an image acquired by shooting of the object, detect a person in the image, set a parameter for focusing, set the parameter to a first parameter in a case where the action of the object is not a specific action, set the parameter to a second parameter different from the first parameter in a case where the action of the object is the specific action, set the parameter to the first parameter in a case where the action of the object is the specific action and the person is not a specific person, and set the parameter to the second parameter in a case where the action of the object is the specific action and the person is the specific person. One or more embodiments of a focusing method corresponding to the above one or more focusing apparatuses also constitute another aspect of the disclosure. A storage medium storing a program that causes a computer to execute the above focusing methods also constitutes another aspect of the disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a block diagram of an image pickup apparatus having a focusing apparatus according to one embodiment of the disclosure.

FIG. 2 illustrates a menu screen for specifying autofocus (AF) operation settings.

FIG. 3 is a flowchart illustrating a focusing method.

FIG. 4 is a flowchart illustrating an action of an object (object action) registration method.

FIGS. 5A and 5B illustrate examples of input images during object action registration.

FIG. 6 is a display example on the monitor screen in a case where the registered operation settings are configured.

FIGS. 7A and 7B illustrate the setting timing of the AF operation settings.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitors) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### Configuration of Focusing Apparatus

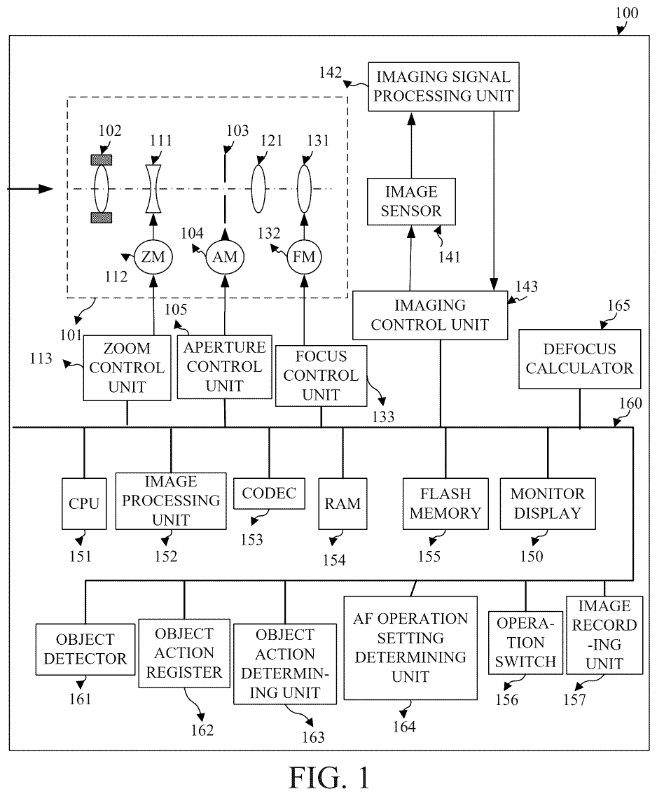

FIG. 1 is a block diagram of an image pickup apparatus 100 having a focusing apparatus according to one embodiment of the disclosure. The image pickup apparatus 100 is a digital still camera or video camera capable of capturing an object image and recording moving image data and still image data into a variety of media such as a tape, a solid-state memory, an optical disc, and a magnetic disk, but the disclosure is not limited to this example. Each unit in the image pickup apparatus 100 is connected via a bus 160. Each unit is also controlled by a CPU 151.

A lens unit 101 includes a fixed first lens unit 102, a zoom lens 111, an aperture stop 103, a fixed third lens unit 121, and a focus lens 131.

An aperture control unit 105 adjusts the aperture diameter of the aperture stop 103 by driving the aperture stop 103 via an aperture motor (AM) 104 according to instructions from the CPU 151, thereby adjusting the light amount during shooting (or imaging).

A zoom control unit 113 changes the focal length by driving the zoom lens 111 via a zoom motor (ZM) 112.

A focus control unit 133 determines a driving amount for driving a focus motor (FM) 132 based on a shift amount (defocus amount) in a focusing direction of the lens unit 101. The focus control unit 133 controls the focusing state by driving the focus lens 131 via the focus motor (FM) 132. AF control is achieved by the movement control of the focus lens 131 by the focus control unit 133 and the focus motor 132.

The focus lens 131 is a lens used for focusing, and although it is simply illustrated as a single lens in FIG. 1, it usually includes a plurality of lenses. An object image (optical image) formed on the imaging surface of an image sensor 141 via the lens unit 101 is converted into an electrical signal (imaging signal) by the image sensor 141. The image sensor 141 is a photoelectric conversion element that performs photoelectric conversion of the object image into an electrical signal. On the imaging surface of the image sensor 141, light receiving elements are arranged in m pixels horizontally and n pixels vertically. The electrical signal output from the image sensor 141 is processed by an imaging signal processing unit 142 as an image signal (image data), allowing the image of the imaging surface to be acquired.

The image data output from the imaging signal processing unit 142 is sent to an imaging control unit 143 and temporarily stored in a RAM 154. The image data stored in the RAM 154 is compressed by an image compression/decompression unit (CODEC) 153 and then recorded on the image recording medium 157. The image data stored in the RAM 154 is also sent to the image processing unit 152. The image processing unit 152 performs processing such as reducing or enlarging the image data to an optimal size and calculating the similarity between image data. By properly sending the image data processed to the optimal size to a monitor display (display unit) 150 for display, preview image display, and through-image display can be performed, and the object detection result of an object detector (detector) 161 can also be superimposed and displayed on the image data. By using the RAM 154 as a ring buffer, multiple image data acquired within a predetermined period, and the detection result of the object detector 161 for each image data, can be buffered.

An operation switch 156 is an input interface including a touch panel and buttons, and a variety of operations can be performed by selecting and operating a variety of function icons displayed on the monitor display 150.

The CPU 151 determines the accumulation time of the image sensor 141 and the gain setting value during an output from the image sensor 141 to the imaging signal processing unit 142, based on an instruction from the user via the operation switch 156 or the magnitude of the pixel signal of the image data stored in the RAM 154. The imaging control unit 143 receives instructions for the accumulation time and gain setting value from the CPU 151 and controls the image sensor 141.

The object detector 161 determines an area where a predetermined object exists, using the image signal. The object is detected based on a previously created trained dictionary targeting people, animals, etc. As a detection method based on training, there is a method called a convolutional neural network (CNN). In CNN, inference processing is executed based on the image signal and dictionary data, which are processing parameters, and the dictionary data is generated in advance by learning processing based on training data.

The focus control unit 133 controls AF for a specific object area.

The aperture control unit 105 controls the exposure using the luminance value of a specific object area.

The image processing unit 152 performs gamma correction, white balance processing, etc., based on the object area.

The monitor display 150 displays images, object detection results, etc., using rectangles or other shapes.

A flash memory (memory) 155 records a control program for the operation of the image pickup apparatus 100 and parameters for the operation of each unit. When the image pickup apparatus 100 is started by user operation (when it transitions from the power-off state to the power-on state), the control program and parameters stored in the flash memory 155 are loaded into the RAM 154. The CPU 151 controls the operation of the image pickup apparatus 100 according to the control program and parameters loaded into the RAM 154.

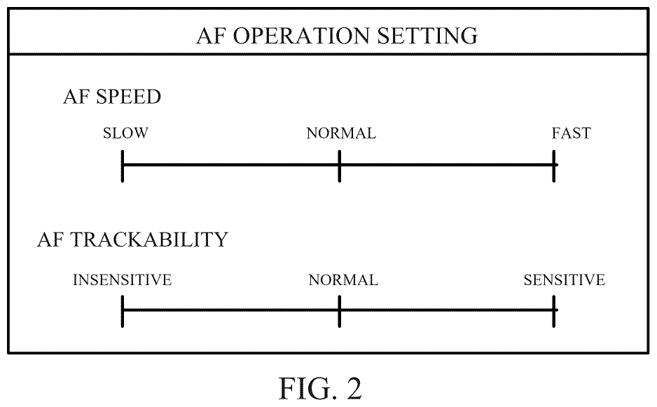

The user can operate the menu screen illustrated in FIG. 2, which is displayed on the monitor display 150, to specify (set) the AF operation settings (parameters) controlled by the focus control unit 133. In FIG. 2, the AF operation settings include the AF speed and AF trackability (sensitivity). The value set by the user is recorded in the flash memory 155.

An object action register (registration unit) 162 records (registers) an object action (specific action) set by the user in the flash memory 155. The object action register 162 also records the AF operation setting value corresponding to the object action to be registered in the flash memory 155. The object action register 162 may also record a characteristic object in a shooting scene corresponding to the object action to be registered in the flash memory 155.

The object action determining unit (determining unit) 163 determines whether the object action in an image signal is the object action registered by the object action register 162.

The AF operation setting determining unit (setting unit) 164 determines whether to switch to the AF operation setting corresponding to the object action when it is determined that the object action registered by the object action determining unit 163 exists in the image signal, and reflects this in the control by the focus control unit 133.

A defocus calculator 165 calculates a defocus amount from the image pickup apparatus 100 for an arbitrary area in the image. The defocus amount may be calculated at a single point, or it may be calculated at equal intervals across the entire image and output as a defocus map. The generated defocus information is recorded in the RAM 154 and referenced by the image processing unit 152. The focus control unit 133 calculates the focus drive amount based on the defocus information and performs focusing.

In this embodiment, the focusing apparatus includes the object detector 161 and the AF operation setting determining unit 164. The focusing apparatus may include at least one of the flash memory 155, the object action register 162, and an object action determining unit 163.

### Processing Flow

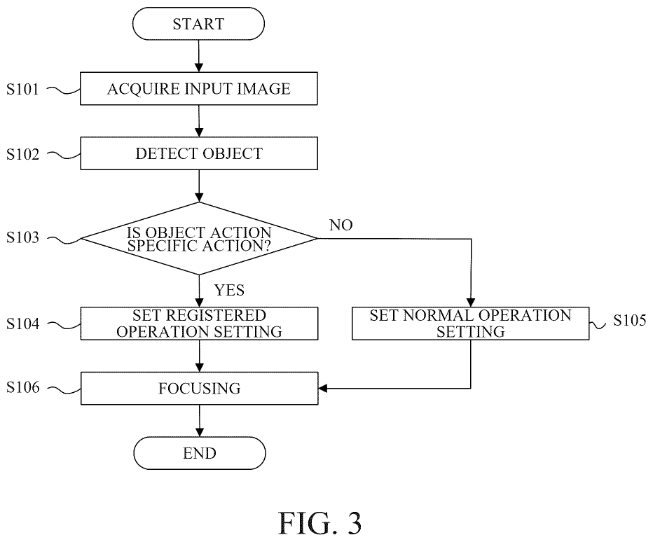

Hereinafter, a focusing method according to this embodiment will be described with reference to FIG. 3. FIG. 3 is a flowchart illustrating the focusing method. It is assumed that the AF operation setting is set to the normal operation setting (first parameter), which is the default setting.

In step S101, the object detector 161 acquires an input image from the imaging control unit 143.

In step S102 (detecting step), the object detector 161 detects an object in the input image. In this embodiment, the object detector 161 outputs the head and torso areas of a person as rectangles. The object detector 161 also detects each joint point of the person and detects the posture and movement of the person based on each joint point. Furthermore, the object detector 161 can detect the shooting scene in the input image. In this embodiment, the object detector 161 detects the shooting scene by detecting a characteristic object in the shooting scene (such as a soccer ball in a soccer scene, and a knife and cutting board in a cooking scene).

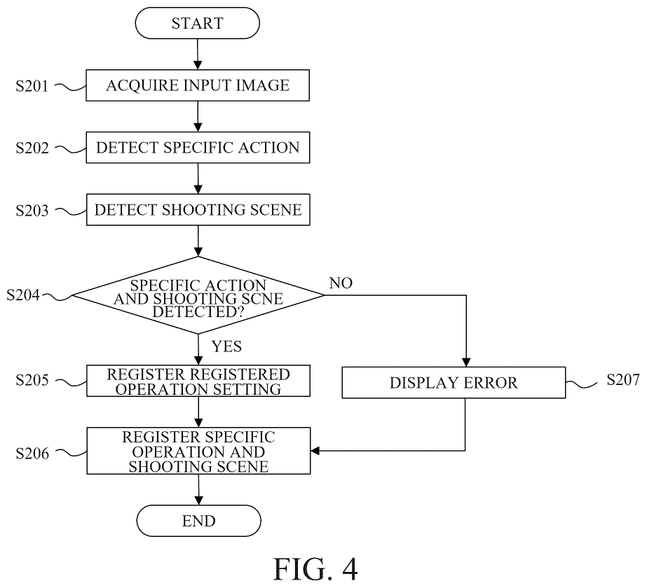

An object action registration method according to this embodiment will be described with reference to FIG. 4. FIG. 4 is a flowchart illustrating the object registration method. The object action registration method is performed before shooting.

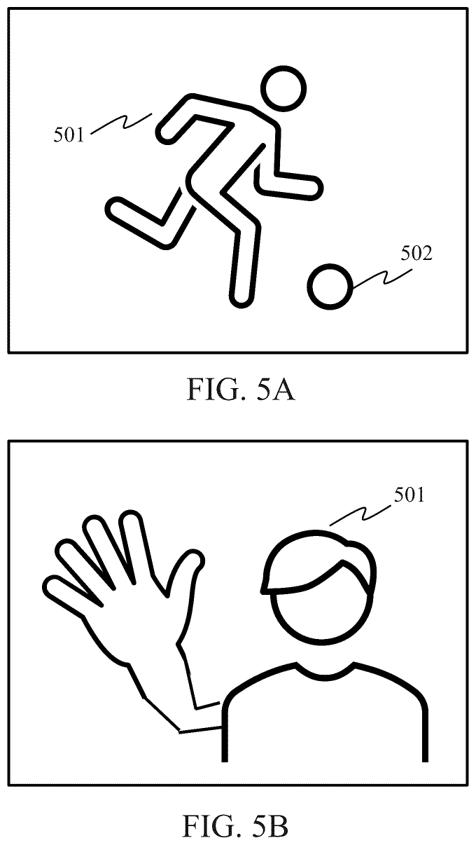

In step S201, the object action register 162 acquires an input image. At this time, the object is performing the action (specific action) of the object to be registered, as illustrated in FIGS. 5A and 5B. In FIG. 5A, a person 501 is dribbling a soccer ball 502, and in FIG. 5B, a person 501 is waving their hand.

In step S202, the object action register 162 detects the specific action. The object detector 161 detects each joint point of the person and detects the posture and movement of the person. At this time, characteristics of the person for identifying the same person may be detected. Detecting the characteristics of each person and registering them along with specific actions can register unique actions for each user.

In step S203, the object action register 162 detects the shooting scene. In this embodiment, the object action register 162 detects the shooting scene by detecting a characteristic object in the shooting scene (such as a soccer ball in a soccer scene, and a knife and cutting board in a cooking scene).

In step S204, the object action register 162 determines whether a specific action and shooting scene have been detected. In a case where the object action register 162 determines that a specific action and shooting scene have been detected, it executes the processing of step S205; otherwise, it executes the processing of step S206.

In step S205, the object action register 162 first displays a menu screen like the one illustrated in FIG. 2 on the monitor display 150. Next, the object action register 162 acquires (registers) the registered operation setting (second parameter), which is the AF operation setting corresponding to the specific action detected in step S202 and selected by the user. The object action register 162 also records the acquired AF registered operation setting in the flash memory 155.

In step S206, the object action register 162 registers the specific action detected in step S202 and the shooting scene detected in step S203, and records them in the flash memory 155. The information recorded in the flash memory 155 in steps S205 and S206 is tagged and managed by the object action register 162.

In step S207, the object action register 162 displays undetected information on the monitor display 150 (error display). Information indicating the cause of the registration failure may also be displayed.

The above is the object action registration method. The specific action is changeable. Here, “change” includes updating or adding a specific action, and deleting at least one of the registered specific actions. Enabling the specific action to change can improve convenience. In this embodiment, the shooting scene was also registered, but if the determination of whether to change the AF operation setting is based only on the specific action, the processing of detecting and recording the shooting scene may be omitted.

Returning to the flowchart in FIG. 3, the description continues.

In step S103, the object action determining unit 163 determines whether the action of the object in the input image is a specific action registered in the object action register 162. The object action determining unit 163 makes the determination based on the similarity of the posture and motion of the person detected by the object detector 161. The object action determining unit 163 executes the processing of step S104 in a case where it determines that the object action is a specific action; otherwise, it executes the processing of step S105. The object action register 162 may perform the determination using not only the posture and motion of the person, but also the similarity of a characteristic object in the shooting scene and the matching of characteristic information of the person to determine whether it is the same person as the registered person. The object action register 162 may also detect and determine each user specific action. The object action register 162 may also be configured to determine the action only of the registered person.

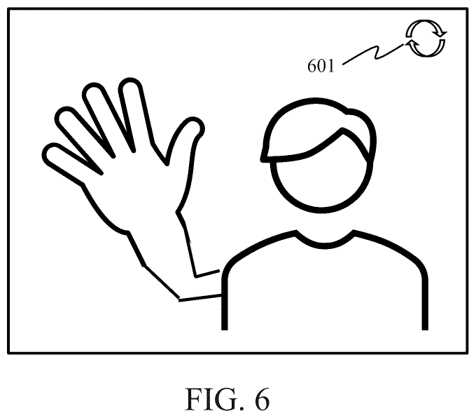

In step S104 (setting step), the AF operation setting determining unit 164 sets the AF operation setting to the registered operation setting. At this time, the user may be notified that the registered operation setting has been set by a notifying unit. For example, the monitor display 150 may function as the notifying unit. In this case, as illustrated in FIG. 6, an icon 601 indicating that the registered operation setting has been set may be displayed superimposed on the input image on the monitor display 150. Alternatively, a light emitting element such as an LED may function as a notifying unit. In this case, the light emitting element may be configured to emit light of a specific color or to blink while the registered operation setting is set.

In step S105 (setting step), the AF operation setting determining unit 164 sets the AF operation setting to the normal operation setting.

In step S106, the focus control unit 133 performs focusing based on the AF operation setting set in step S104 or S105.

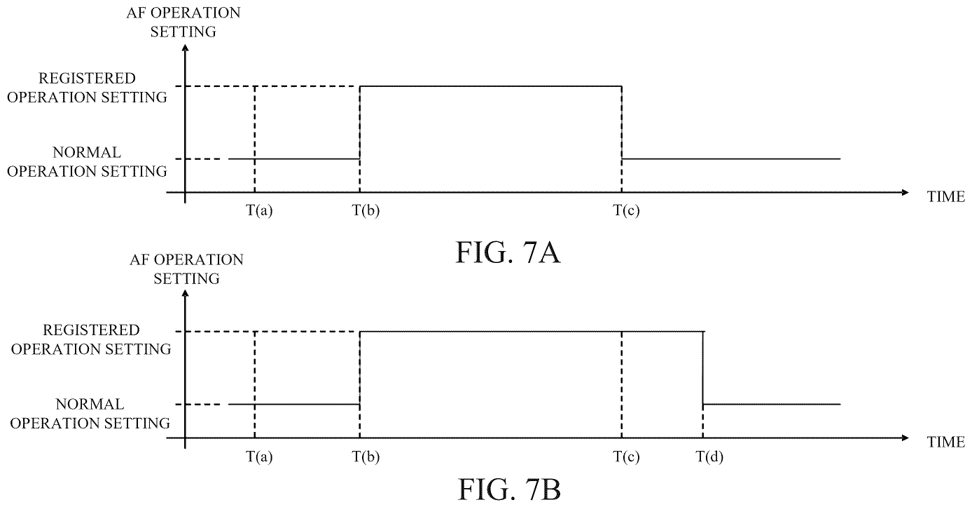

The switching to the registered operation setting may have different adaptation periods between focusing for a different object or focusing for the same object. A specific example will be explained with reference to FIGS. 7A and 7B. FIG. 7A illustrates an example of switching to a different object. At time T(a), when the object action is determined not to be a specific action, the normal operation setting is set, and at time T(b), when the object action is determined to be a specific action, the registered operation setting is set. At time T(c), when the object action is determined not to be a specific action, the focus setting is reset to the normal operation setting. FIG. 7B illustrates switching to the same object, for example, initially only the upper body of a person is captured, and then the focus is shifted to the hand along with the action of the registered hand. Initially, similarly to FIG. 7A, at time T(b) when the object action is determined to be a specific action, the registered operation setting is set and the focusing on the hand (first area) is performed. Next, in a case where at time T(c) the object action is determined not to be a specific action, and the focus is shifted back to the person's face (second area), the normal operation setting is not set at time T(c), but rather at time T(d) when the focusing on the person's face is completed.

Thus, this embodiment can perform focusing that properly switches the AF operation setting according to the shooting scene during moving image shooting.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-006715, filed on Jan. 17, 2025, which is hereby incorporated by reference herein in its entirety.

What is claimed is:

1. A focusing apparatus comprising:
one or more memories storing instructions; and
one or more processors that, upon execution of the instructions, operate to:
detect an action of an object in an image acquired by shooting of the object,
detect a shooting scene in the image,
set a parameter for focusing,
set the parameter to a first parameter in a case where the action of the object is not a specific action,
set the parameter to a second parameter different from the first parameter in a case where the action of the object is the specific action,
set the parameter to the first parameter in a case where the action of the object is the specific action and the shooting scene is not a specific shooting scene, and
set the parameter to the second parameter in a case where the action of the object is the specific action and the shooting scene is the specific shooting scene.

2. The focusing apparatus according to claim 1, wherein the one or more processors operate to:
detect a person in the image,
set the parameter to the first parameter in a case where the action of the object is the specific action, the shooting scene is the specific shooting scene, and the person is not a specific person, and
set the parameter to the second parameter in a case where the action of the object is the specific action, the shooting scene is the specific shooting scene, and the person is the specific person.

3. The focusing apparatus according to claim 1, further comprising a notifying unit configured to notify that the parameter is set to the second parameter.

4. The focusing apparatus according to claim 3, wherein the notifying unit is a display unit configured to display the image, and
wherein the display unit displays an icon superimposed on the image indicating that the parameter is set to the second parameter in a case where the parameter is set to the second parameter.

5. The focusing apparatus according to claim 1, wherein the one or more processors operate to register the specific action in the one or more memories.

6. The focusing apparatus according to claim 5, wherein the one or more processors operate to change the specific action.

7. The focusing apparatus according to claim 1, wherein the one or more processors operate to register the specific shooting scene in association with the specific action.

8. The focusing apparatus according to claim 1, wherein the one or more processors operate to determine whether the action of the object is the specific action.

9. The focusing apparatus according to claim 1, wherein the parameter includes at least one of speed and sensitivity.

10. A focusing apparatus comprising:
one or more memories storing instructions; and
one or more processors that, upon execution of the instructions, operate to:
detect an action of an object in an image acquired by shooting of the object,
detect a person in the image,
set a parameter for focusing,
set the parameter to a first parameter in a case where the action of the object is not a specific action,
set the parameter to a second parameter different from the first parameter in a case where the action of the object is the specific action,
set the parameter to the first parameter in a case where the action of the object is the specific action and the person is not a specific person, and
set the parameter to the second parameter in a case where the action of the object is the specific action and the person is the specific person.

11. The focusing apparatus according to claim 10, further comprising a notifying unit configured to notify that the parameter is set to the second parameter.

12. The focusing apparatus according to claim 11, wherein the notifying unit is a display unit configured to display the image, and
wherein the display unit displays an icon superimposed on the image indicating that the parameter is set to a second parameter in a case where the parameter is set to the second parameter.

13. The focusing apparatus according to claim 10, wherein the one or more processors operate to register the specific action in the one or more memories.

14. The focusing apparatus according to claim 13, wherein the one or more processors operate to change the specific action.

15. The focusing apparatus according to claim 10, wherein the one or more processors operate to register the specific person in association with the specific action.

16. The focusing apparatus according to claim 10, wherein the one or more processors operate to determine whether the action of the object is the specific action.

17. The focusing apparatus according to claim 16, wherein the one or more processors operate to determine whether the action of the object is the specific action in a case where the registered specific person is detected.

18. The focusing apparatus according to claim 10, wherein the parameter includes at least one of speed and sensitivity.

19. A focusing method comprising:
detecting an action of an object in an image acquired by shooting of the object,
detecting a shooting scene in the image,
setting a parameter for focusing,
setting the parameter to a first parameter in a case where the action of the object is not a specific action,
setting the parameter to a second parameter different from the first parameter in a case where the action of the object is the specific action,
setting the parameter to the first parameter in a case where the action of the object is the specific action and the shooting scene is not a specific shooting scene, and
setting the parameter to the second parameter in a case where the action of the object is the specific action and the shooting scene is the specific shooting scene.

20. A focusing method comprising:
detecting an action of an object in an image acquired by shooting of the object,
detecting a person in the image,
setting a parameter for focusing,
setting the parameter to a first parameter in a case where the action of the object is not a specific action,
setting the parameter to a second parameter different from the first parameter in a case where the action of the object is the specific action,
setting the parameter to the first parameter in a case where the action of the object is the specific action and the person is not a specific person, and
setting the parameter to the second parameter in a case where the action of the object is the specific action and the person is the specific person.

21. A non-transitory computer-readable storage medium storing a program that causes a computer to execute the focusing method according to claim 19.

22. A non-transitory computer-readable storage medium storing a program that causes a computer to execute the focusing method according to claim 20.
